(19) United States
(12) Patent Application Publication
(10) Pub. No.: US 2004/0105084 A1
(43) Pub. Date: Jun. 3, 2004

(54) Lithographic apparatus and device manufacturing method

(75) Inventors: Ralph Kurt, Eindhoven (NL); Aleksey Kolesnychenko, Nijmegen (NL)

Correspondence Address: PILLSBURY WINTHROP, LLP, P.O. BOX 10500, MCLEAN, VA, 22102, US

(73) Assignee: ASML Netherlands B.V.

(21) Appl. No.: 10/671,864

(22) Filed: Sep. 29, 2003

(30) Foreign Application Priority Data
Sep. 30, 2002 (EP) 02256792.9

(51) Int. Cl. G03B 27/54

(52) U.S. Cl. 355/67; 355/53; 501/54; 355/71

(57) ABSTRACT

A lithographic apparatus having a supply to a space in the apparatus of a composition including at least one of one or more perhalogenated C₁-C₆ alkanes and one or more compounds including one or more nitrogen atoms and one or more atoms selected from hydrogen, oxygen and halogen. The activation of the alkane(s) and compound(s) provides reactive species which are capable of highly selective etching of hydrocarbon species while minimizing damage to sensitive optical surfaces.

### BACKGROUND OF THE INVENTION

1. Field of the Invention

The present invention relates to a lithographic projection apparatus and device manufacturing method.

2. Description of the Related Art

The term “patterning device” as here employed should be broadly interpreted as referring to device that can be used to endow an incoming radiation beam with a patterned cross-section, corresponding to a pattern that is to be created in a target portion of the substrate. The term “light valve” can also be used in this context. Generally, the pattern will correspond to a particular functional layer in a device being created in the target portion, such as an integrated circuit or other device (see below). An example of such a patterning device is a mask. The concept of a mask is well known in lithography, and it includes mask types such as binary, alternating phase-shift, and attenuated phase-shift, as well as various hybrid mask types. Placement of such a mask in the radiation beam causes selective transmission (in the case of a transmissive mask) or reflection (in the case of a reflective mask) of the radiation impinging on the mask, according to the pattern on the mask. In the case of a mask, the support structure will generally be a mask table, which ensures that the mask can be held at a desired position in the incoming radiation beam, and that it can be moved relative to the beam if so desired.

Another example of a patterning device is a programmable mirror array. One example of such an array is a matrix-addressable surface having a viscoelastic control layer and a reflective surface. The basic principle behind such an apparatus is that, for example, addressed areas of the reflective surface reflect incident light as diffracted light, whereas unaddressed areas reflect incident light as undiffracted light. Using an appropriate filter, the undiffracted light can be filtered out of the reflected beam, leaving only the diffracted light behind. In this manner, the beam becomes patterned according to the addressing pattern of the matrix-addressable surface. An alternative embodiment of a programmable mirror array employs a matrix arrangement of tiny mirrors, each of which can be individually tilted about an axis by applying a suitable localized electric field, or by employing piezoelectric actuators. Once again, the mirrors are matrix-addressable, such that addressed mirrors will reflect an incoming radiation beam in a different direction to unaddressed mirrors. In this manner, the reflected beam is patterned according to the addressing pattern of the matrix-addressable mirrors. The required matrix addressing can be performed using suitable electronics. In both of the situations described hereabove, the patterning device can comprise one or more programmable mirror arrays. More information on mirror arrays as here referred to can be seen, for example, from U.S. Pat. Nos. 5,296,891 and 5,523,193, and WO 98/38597 and WO 98/33096. In the case of a programmable mirror array, the support structure may be embodied as a frame or table, for example, which may be fixed or movable as required.

Another example of a patterning device is a programmable LCD array. An example of such a construction is given in U.S. Pat. No. 5,229,872. As above, the support structure in this case may be embodied as a frame or table, for example, which may be fixed or movable as required.

For purposes of simplicity, the rest of this text may, at certain locations, specifically direct itself to examples involving a mask and mask table. However, the general principles discussed in such instances should be seen in the broader context of the patterning device as hereabove set forth.

Lithographic projection apparatus can be used, for example, in the manufacture of integrated circuits (ICs). In such a case, the patterning device may generate a circuit pattern corresponding to an individual layer of the IC, and this pattern can be imaged onto a target portion (e.g. comprising one or more dies) on a substrate (silicon wafer) that has been coated with a layer of radiation-sensitive material (resist). In general, a single wafer will contain a whole network of adjacent target portions that are successively irradiated via the projection system, one at a time. In current apparatus, employing patterning by a mask on a mask table, a distinction can be made between two different types of machine. In one type of lithographic projection apparatus, each target portion is irradiated by exposing the entire mask pattern onto the target portion at once. Such an apparatus is commonly referred to as a wafer stepper. In an alternative apparatus, commonly referred to as a step-and-scan apparatus, each target portion is irradiated by progressively scanning the mask pattern under the projection beam in a given reference direction (the “scanning” direction) while synchronously scanning the substrate table parallel or anti-parallel to this direction. Since, in general, the projection system will have a magnification factor M (generally <1), the speed V at which the substrate table is scanned will be a factor M times that at which the mask table is scanned. More information with regard to lithographic devices as here described can be seen, for example, from U.S. Pat. No. 6,046,792.

In a known manufacturing process using a lithographic projection apparatus, a pattern (e.g. in a mask) is imaged onto a substrate that is at least partially covered by a layer of radiation-sensitive material (resist). Prior to this imaging, the substrate may undergo various procedures, such as priming, resist coating and a soft bake. After exposure, the substrate may be subjected to other procedures, such as a post-exposure bake (PEB), development, a hard bake and measurement/inspection of the imaged features. This array of procedures is used as a basis to pattern an individual layer of a device, e.g. an IC. Such a patterned layer may then undergo various processes such as etching, ion-implantation (doping), metallization, oxidation, chemo-mechanical polishing, etc., all intended to finish off an individual layer. If several layers are required, then the whole procedure, or a variant thereof, will have to be repeated for each new layer. It is important to ensure that the overlay (juxtaposition) of the various stacked layers is as accurate as possible. For this purpose, a small reference mark is provided at one or more positions on the wafer, thus defining the origin of a coordinate system on the wafer. Using optical and electronic devices in combination with the substrate holder positioning device (referred to hereinafter as “alignment system”), this mark can then be relocated each time a new layer has to be juxtaposed on an existing layer, and can be used as an alignment reference. Eventually, an array of devices will be present on the substrate (wafer). These devices are then separated from one another by a technique such as dicing or sawing, whence the individual devices can be mounted on a carrier, connected to pins, etc. Further information regarding such processes can be obtained, for example, from the book “Microchip Fabrication: A Practical Guide to Semiconductor Processing”, Third Edition, by Peter van Zant, McGraw Hill Publishing Co., 1997, ISBN 0-07-067250-4.

For the sake of simplicity, the projection system may hereinafter be referred to as the “lens.” However, this term should be broadly interpreted as encompassing various types of projection system, including refractive optics, reflective optics, and catadioptric systems, for example. The radiation system may also include components operating according to any of these design types for directing, shaping or controlling the projection beam of radiation, and such components may also be referred to below, collectively or singularly, as a “lens”. Further, the lithographic apparatus may be of a type having two or more substrate tables (and/or two or more mask tables). In such “multiple stage” devices the additional tables may be used in parallel or preparatory steps may be carried out on one or more tables while one or more other tables are being used for exposures. Dual stage lithographic apparatus are described, for example, in U.S. Pat. Nos. 5,969,441 and 6,262,796.

In all of the above-mentioned systems, radiation-induced carbon contamination, causing the formation of films on optical elements, is a considerable problem. Even very thin carbon films can absorb a remarkable amount of the projection beam leading to a reduction in energy throughput in the optical train. Further, these carbon films may be non-homogeneous and as such can result in phase shifts and patterning errors. An effective strategy is therefore required to mitigate the effects of carbon contamination.

A standard approach used to date to address such problems involves the addition of O₂ and/or H₂ gas to the system in relatively high concentrations, followed by UV irradiation. However, this known technique has inherent disadvantages. In the case of optical lithography (e.g. 193 nm and 157 nm systems), it is thought that cleaning of the carbon contamination occurs through direct cracking of hydrocarbons in the gas phase by photons. While this technique has been shown to reduce the rate of carbon growth in some situations, a temporarily higher hydrocarbon partial pressure is induced by the cracking process. This in turn subsequently induces the growth of a carbon film. Thus, the known technique is not effective in all situations.

More significant problems are experienced when the technique is applied to EUV systems. EUV tools typically employ multi-layer mirrors, which have highly sensitive surfaces. The standard O₂/UV cleaning method frequently not only etches away the carbon film on the surface of the mirror, but also damages the capping layer of the mirror. Such damage is typically irreversible and hence leads to a loss in reflectivity. An improved carbon cleaning method is therefore required, in particular in the field of EUV lithography.

### SUMMARY OF THE INVENTION

It is an aspect of the present invention to provide a lithographic projection apparatus having in-situ control of molecular contamination, which can effectively be used in both DUV and EUV lithography.

This and other aspects are addressed according to an embodiment of the present invention in a lithographic apparatus including a radiation system configured to supply a projection beam of radiation; a support configured to support a patterning device, the patterning device configured to pattern the projection beam according to a desired pattern; a substrate table configured to hold a substrate; a projection system configured to project the patterned beam onto a target portion of the substrate; and a supply configured to supply to a space in the apparatus a composition including one or more perhalogenated C₁-C₆ alkanes; and one or more compounds consisting essentially of one or more nitrogen atoms and one or more atoms selected from hydrogen, oxygen and halogen.

The lithographic apparatus of the present invention provides a supply of one or more of the compounds set out above, typically together with nitrogen, hydrogen and/or one or more inert gases. The compound, or mixture of compounds, provided to the space is hereinafter referred to as the composition. The composition may consist of a single compound in pure form or may be a mixture of compounds.

The composition is supplied to a space in the apparatus, for example into the projection system. Activation of this composition either by applying the projection beam to the space containing the composition, or by use of an alternative activation source, leads to the excitation or dissociation of the compounds into various reactive species. These reactive species act as highly selective etching components, efficiently removing hydrocarbons without causing damage to the surface of any EUV mirrors present. In addition, the compositions used in the present invention typically provide a high etching rate of hydrocarbon species. Their light absorption is also generally low and the introduction of such materials into the optical train therefore has little or no adverse effect on transmissivity.

In a preferred embodiment of the invention, the composition includes nitrogen dioxide. Nitrogen dioxide possesses various properties which make it more advantageous than oxygen as a cleaning agent. Firstly, it has a much lower dissociation energy than oxygen and can therefore easily be dissociated by photons and secondary electrons. Secondly, the activation of nitrogen dioxide leads to the formation of ozone, itself a highly effective etching agent. Thirdly, the sticking probability for nitrogen dioxide is significantly higher than that for oxygen, ensuring that a large amount of the cleaning agent is present on the surfaces to be cleaned.

As a result of these advantages, cleaning can be carried out using much lower pressures of cleaning agent than are required in a corresponding process where oxygen is used. Further, the more efficient nitrogen dioxide cleaning technique allows a reduced cleaning time to be employed, leading to a reduction in the downtime in the system.

According to a further aspect of the present invention there is provided a device manufacturing method including providing a substrate that is at least partially covered by a layer of radiation-sensitive material; providing a projection beam of radiation using a radiation system; using a patterning device to endow the projection beam with a pattern in its cross-section; projecting the patterned beam of radiation onto a target portion of the layer of radiation-sensitive material; supplying to a space through which the projection beam passes a composition including at least one of one or more perhalogenated C₁-C₆ alkanes and one or more compounds consisting essentially of one or more nitrogen atoms and one or more atoms selected from hydrogen, oxygen and halogen; and producing reactive species of the composition.

According to a further aspect of the present invention, producing the reactive species includes exciting and/or dissociating molecules of the alkanes and/or the one or more compounds.

An embodiment of the present invention is directed to low wavelength lithography systems such as those operating at 193 nm and 157 nm as well as extreme ultraviolet (EUV) lithography tools. Typically, EUV systems operate using a wavelength of below about 50 nm, preferably below about 20 nm, and most preferably below about 15 nm. An example of a wavelength in the EUV region which is gaining considerable interest in the lithography industry is 13.4 nm, though there are also other promising wavelengths in this region, such as 11 nm, for example.

Although specific reference may be made in this text to the use of the apparatus according to an embodiment of the invention in the manufacture of ICs, it should be explicitly understood that such an apparatus has many other possible applications. For example, it may be employed in the manufacture of integrated optical systems, guidance and detection patterns for magnetic domain memories, liquid-crystal display panels, thin-film magnetic heads, etc. The skilled artisan will appreciate that, in the context of such alternative applications, any use of the terms “reticle”, “wafer” or “die” in this text should be considered as being replaced by the more general terms “mask”, “substrate” and “target portion”, respectively.

In the present document, the terms “radiation” and “beam” are used to encompass all types of electromagnetic radiation, including ultraviolet radiation (e.g. with a wavelength of 365, 248, 193, 157 or 126 nm) and EUV (extreme ultra-violet radiation, e.g. having a wavelength in the range 5-20 nm), as well as particle beams, such as ion beams or electron beams.

### BRIEF DESCRIPTION OF THE DRAWINGS

Embodiments of the invention will now be described, by way of example only, with reference to the accompanying schematic drawings in which:

FIG. 1 depicts a lithographic projection apparatus according to an embodiment of the present invention; and

FIG. 2 depicts the radiation system of a lithographic apparatus according to an embodiment of the present invention.

In the Figures, corresponding reference symbols indicate corresponding parts.

### DETAILED DESCRIPTION

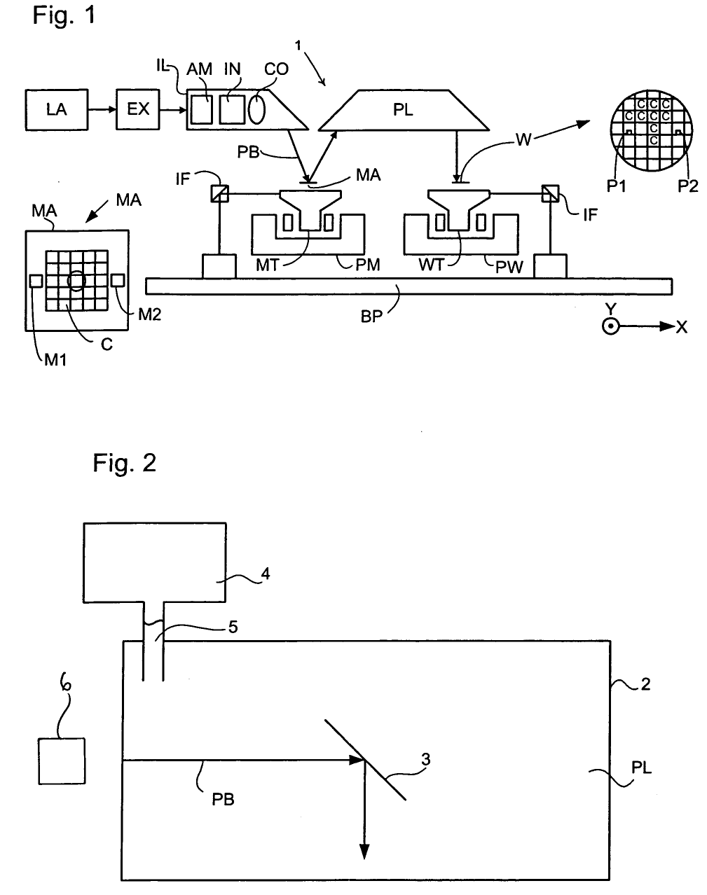

FIG. 1 schematically depicts a lithographic projection apparatus 1 according to an embodiment of the invention. The apparatus 1 includes a base plate BP. The apparatus may also include a radiation source LA (e.g. UV or EUV radiation, such as, for example, generated by an excimer laser operating at a wavelength of 248 nm, 193 nm or 157 nm, or by a laser-fired plasma source operating at 13.6 nm). A first object (mask) table MT is provided with a mask holder configured to hold a mask MA (e.g. a reticle), and is connected to a first positioning device PM that accurately positions the mask with respect to a projection system or lens PL. A second object (substrate) table WT is provided with a substrate holder configured to hold a substrate W (e.g. a resist-coated silicon wafer), and is connected to a second positioning device PW that accurately positions the substrate with respect to the projection system PL. The projection system or lens PL (e.g. a mirror group) is configured to image an irradiated portion of the mask MA onto a target portion C (e.g. comprising one or more dies) of the substrate W.

As here depicted, the apparatus is of a reflective type (i.e. has a reflective mask). However, in general, it may also be of a transmissive type, for example with a transmissive mask. Alternatively, the apparatus may employ another kind of patterning device, such as a programmable mirror array of a type as referred to above.

The source LA (e.g. a discharge or laser-produced plasma source) produces radiation. This radiation is fed into an illumination system (illuminator) IL, either directly or after having traversed a conditioning device, such as a beam expander Ex, for example. The illuminator IL may comprise an adjusting device AM configured to set the outer and/or inner radial extent (commonly referred to as σ-outer and σ-inner, respectively) of the intensity distribution in the projection beam PB. In addition, it will generally comprise various other components, such as an integrator IN and a condenser CO. In this way, the projection beam PB impinging on the mask MA has a desired uniformity and intensity distribution in its cross-section.

It should be noted with regard to FIG. 1 that the source LA may be within the housing of the lithographic projection apparatus, as is often the case when the source LA is a mercury lamp, for example, but that it may also be remote from the lithographic projection apparatus, the radiation which it produces being led into the apparatus (e.g. with the aid of suitable directing mirrors). This latter scenario is often the case when the source LA is an excimer laser. The present invention encompasses both of these scenarios.

The beam PB subsequently intercepts the mask MA, which is held on a mask table MT. Having traversed the mask MA, the beam PB passes through the lens PL, which focuses the beam PB onto a target portion C of the substrate W. With the aid of the second positioning device PW and interferometer(s) IF, the substrate table WT can be moved accurately, e.g. so as to position different target portions C in the path of the beam PB. Similarly, the first positioning device PM can be used to accurately position the mask MA with respect to the path of the beam PB, e.g. after mechanical retrieval of the mask MA from a mask library, or during a scan. In general, movement of the object tables MT, WT will be realized with the aid of a long-stroke module (coarse positioning) and a short-stroke module (fine positioning), which are not explicitly depicted in FIG. 1. However, in the case of a wafer stepper (as opposed to a step and scan apparatus) the mask table MT may just be connected to a short stroke actuator, or may be fixed. The mask MA and the substrate W may be aligned using mask alignment marks M₁, M₂ and substrate alignment marks P₁, P₂.

The depicted apparatus can be used in two different modes:

1. In step mode, the mask table MT is kept essentially stationary, and an entire mask image is projected at once, i.e. a single “flash,” onto a target portion C. The substrate table WT is then shifted in the X and/or Y directions so that a different target portion C can be irradiated by the beam PB;

2. In scan mode, essentially the same scenario applies, except that a given target portion C is not exposed in a single “flash.” Instead, the mask table MT is movable in a given direction (the so-called “scan direction”, e.g., the Y direction) with a speed v, so that the projection beam PB is caused to scan over a mask image. Concurrently, the substrate table WT is simultaneously moved in the same or opposite direction at a speed V=Mv, in which M is the magnification of the lens PL (typically, M=¼ or ⅕). In this manner, a relatively large target portion C can be exposed, without having to compromise on resolution.

FIG. 2 schematically depicts the projection system of an embodiment of the present invention in more detail. In this embodiment, the space to which the composition is supplied is the projection system PL. In alternative embodiments, the space is typically any area in the apparatus through which the projection beam passes. Preferred spaces are those containing at least a part of the radiation system and/or at least a part of the projection system. Preferably, the space contains at least one mirror.

As depicted in FIG. 2, the projection system comprises a mirror 3 and optionally various other optical components as described above with reference to FIG. 1. The projection system is contained within a chamber 2. The chamber is supplied with the composition disclosed herein from a supply 4, which may be a pressurized container containing a liquid or gaseous form of the composition. The composition is supplied to the chamber 2 by an inlet 5, which may include a valve. The composition is typically supplied to the chamber in gaseous form or as a beam of molecules. However, it may alternatively be supplied in the form of a liquid or solid. The liquid is then evaporated or the solid is sublimed, providing the composition in the space in gaseous form. A further supply of the composition is to provide the composition encapsulated in microporous media. For example, a zeolite having molecules of the composition in the cavities in its structure may be provided. Once introduced into the space, the zeolite is, for example, heated in order to liberate the composition.

Where the composition contains more than one compound, two or more supplies may be present, each supply, for example, supplying one compound to the space. Alternatively, each compound may be supplied via the same supply either together or at different times. Any reference above to the supply of the composition therefore also includes reference to the supply of one of the compounds of the composition.

Typically, the lithographic apparatus contains the composition. For example, the composition may be present in the supply 4 and/or in the chamber 2 (typically the projection system). However, as will be apparent, it may also be separately supplied to the lithographic apparatus.

After its introduction into the space in the apparatus, the composition is activated by an activation device 6. Typically, activation is carried out at a separate time from, for example prior to, exposing the substrate. The space is then optionally purged or evacuated to remove the composition prior to exposure. Activation can be achieved, for example, by irradiating the space containing the composition with the projection beam. However, alternative activation may be used, provided the activation is capable of dissociating or exciting at least some (and preferably the majority) of the molecules in the composition. Examples of alternative activation are additional UV sources, for example a DUV or EUV source, plasma sources, an electrical or magnetic field or electron irradiation. It is preferred that the activation is by the projection beam itself, in particular when using an EUV projection beam, since this leads to a high degree of dissociation of the compounds in the composition and thus enhanced cleaning efficiency.

Activation occurs principally two ways. Firstly, dissociation or excitation may occur directly by photons when a UV source is used as the activation. Secondly, activation may occur due to secondary electrons produced, for example at an irradiated surface or by an electron source. Activation leads to the production of reactive species, in particular molecules which have been excited to a higher energy level and fragments of dissociated molecules.

The reactive species produced provide highly selective etching of carbon films. This is demonstrated by tests carried out on the compositions described herein showing that sp² carbon, i.e. aliphatic hydrocarbon, amorphous and graphitic carbon, is selectively etched in favor of sp³ carbon. While dissociation of hydrocarbons by UV leads to both sp² and sp³ carbon, carbon-contamination layers in lithographic apparatus have been shown to be formed largely of nano-structured graphitic-like films formed from sp² carbon. Thus, the compositions disclosed herein are highly selective for the particular type of contamination which is problematic in lithography apparatus.

The compositions disclosed herein are preferably easily dissociated into reactive species on application of radiation or other activation. A high sticking coefficient is also advantageous since this enhances the possibility of dissociation and the likelihood of reaction with sp² carbon.

Typically, the composition includes one or more compounds selected from perhalogenated C₁-C₆ alkanes, nitrogen dioxide, nitrogen oxoacids, nitrogen hydrides and salts of nitrogen hydrides, the salts including nitrogen, hydrogen, oxygen and halogen atoms. For example, the composition may one or more compounds selected from perhalogenated C₁-C₆ alkanes, nitrogen oxoacids, nitrogen hydrides and salts of nitrogen hydrides, the salts including nitrogen, hydrogen, oxygen and halogen atoms. In these salts, the halogen is typically fluorine, chlorine or bromine, preferably fluorine. Typically, the perhalogenated C₁-C₆ alkanes are perfluorinated C₁-C₆ alkanes. Preferred C₁-C₆ alkanes are C₁-C₄ alkanes, in particular methane and ethane. Thus, preferred perhalogenated C₁-C₆ alkanes are perfluorinated C₁-C₄ alkanes, in particular perfluoromethane and perfluoroethane. Typically the nitrogen oxoacid is nitric acid (HNO₃). The nitrogen hydrides are compounds including only nitrogen and hydrogen atoms. Examples of nitrogen hydrides include ammonia (NH₃), hydrazine (N₂H₄), hydrogen azide (HN₃), ammonium azide (NH₄N₃), hydrazinium azide (N₂H₅N₃), diazene (N₂H₂) and tetrazene (H₂N—N═N—NH₂). Preferred nitrogen hydrides are ammonia, diazene and hydrazine, in particular ammonia. Typically, the salts of nitrogen hydrides are ammonium salts. Examples of ammonium salts include ammonium hydroxide and ammonium halides such as ammonium fluoride, ammonium chloride and ammonium bromide.

Thus, preferred compositions include one or more compounds selected from perfluorinated C₁-C₄ alkanes, nitrogen dioxide, nitric acid, nitrogen hydrides and ammonium salts. Examples of preferred compositions include one or more compounds selected from perfluorinated C₁-C₄ alkanes, nitric acid, nitrogen hydrides and ammonium salts. More preferred compositions include one or more compounds selected from tetrafluoromethane, nitrogen dioxide, nitric acid, ammonium fluoride, ammonium hydroxide, ammonia, diazene and hydrazine, for example tetrafluoromethane, nitric acid, ammonium fluoride, ammonium hydroxide, ammonia, diazene and hydrazine.

Compositions that include only nitrogen and/or hydrogen containing species, optionally together with N₂, H₂ and/or one or more inert gases, are particularly advantageous when ruthenium mirrors are employed. These compounds act as highly selective etching agents, removing substantially all hydrocarbons present in the system while causing little, if any, damage to ruthenium mirrors. Thus, in systems employing ruthenium mirrors, preferred compositions include nitrogen hydrides, optionally together with N₂, H₂ and/or one or more inert gases. More preferred compositions include one or more compounds selected from ammonia, diazene and hydrazine. Most preferred compositions include ammonia. Typically, each of the above compositions includes the above specified nitrogen hydrides together with N₂, H₂ and/or one or more inert gases.

While the nitrogen hydrides provide highly selective etching, other compositions, such as those containing halogen or hydroxide groups, typically provide a faster etching rate. Where a fast etching rate is required, a suitable composition would therefore include one or more compounds selected from perhalogenated C₁-C₆ alkanes, nitrogen oxoacids and ammonium salts, the salts including nitrogen, hydrogen, oxygen and halogen atoms. Preferably such a composition includes one or more compounds selected from perfluorinated C₁-C₄ alkanes, nitric acid and ammonium salts. More preferably a composition for fast etching includes one or more compounds selected from perfluoromethane, perfluoroethane, nitric acid, ammonium fluoride and ammonium hydroxide. These compositions for fast etching are, for example, used when rapid etching of a thick layer of hydrocarbons is required. Nitrogen hydride based compositions are typically employed for general use, due to their improved selectivity. Typically, each of the above compositions includes the above specified compounds together with N₂, H₂ and/or one or more inert gases.

In an alternative embodiment of the invention, the composition includes nitrogen dioxide, which has been found to be a particularly advantageous cleaning substance due to its low dissociation energy and high sticking coefficient. Nitrogen dioxide can be easily dissociated into reactive species such as atomic oxygen and reactive nitrogen oxides, for example:

NO₂+hν→NO+O

The dissociation energy for a nitrogen dioxide molecule is much lower than that for an oxygen molecule. As a result, the nitrogen dioxide molecule can be dissociated directly by a photon with a wavelength of only 397 nm. This is in contrast to an oxygen molecule, which requires 242 nm for dissociation to occur. Dissociation of nitrogen dioxide via secondary electrons also occurs more easily. Furthermore, recombination of the reactive species to re-form a nitrogen dioxide molecule is not favored. Thus, a high proportion of reactive species can be made available in the optical train through a relatively low energy input.

A further advantage of the use of nitrogen dioxide relates to its high sticking coefficient. The physisorption of nitrogen dioxide molecules onto carbon-like surfaces is relatively strong, in particular when compared with the strength of comparable bonds formed by molecular oxygen to carbon-like surfaces. The sticking probability of nitrogen dioxide on silicon, ruthenium and even carbon surfaces is therefore close to one. Given this strength of bonding, a large number of nitrogen dioxide molecules will be bound to the surfaces of the optical elements at any one time. This provides localization of the cleaning agent in the precise position where cleaning is required and thus increases the efficiency of the process.

Nitrogen dioxide can be delivered to the system either alone, mixed with inert gases, or mixed with oxygen, hydrogen and/or water. It has been found that a composition including nitrogen dioxide in combination with existing cleaning agents, in particular oxygen, hydrogen and/or water provides a highly effective cleaning process. In particular, the use of nitrogen dioxide in the presence of oxygen leads to the production of ozone, known to be a particularly effective cleaning agent. For example, ozone can be produced as follows:

NO₂+hν→NO+O

O+O₂→O₃ (ozone)

or

VOCₛ+NOx+hν→O₃+other pollutants

where VOCs represent volatile organic compounds.

Typically, the gaseous composition is provided to the space at a partial pressure which is at least 5, preferably at least 10 times, the partial pressure of hydrocarbon gases in the space. In an EUV system, the gaseous composition is supplied preferably in a ratio of NO2: CxHy of 10²−10⁴, typically as a continuous or quasi-continuous operation. The actual partial pressure of gaseous composition introduced is typically in the order of 10⁻⁴ to 10⁻⁵ mbar. Where the gaseous composition comprises an active cleaning agent as well as inert species, the partial pressures mentioned above typically refer to the pressure of the cleaning agent. In general, it is possible to select suitable partial pressures for use based on the techniques known in the art. However, the lower absorption rate of the gaseous compositions disclosed herein means that higher partial pressures can be tolerated than may have been used with the standard O₂/UV technique.

While specific embodiments of the invention have been described above, it will be appreciated that the invention may be practiced otherwise than as described. The description is not intended to limit the invention.

What is claimed is:

1. A lithographic projection apparatus, comprising:
a radiation system configured to provide a projection beam of radiation;
a support configured to support a patterning device, the patterning device configured to pattern the projection beam according to a desired pattern;
a substrate table configured to hold a substrate; and
a projection system configured to project the patterned beam onto a target portion of the substrate, wherein a space in the apparatus comprises a composition containing at least one of (a) and (b), wherein (a) is one or more perhalogenated C₁-C₆ alkanes and (b) is one or more compounds including one or more nitrogen atoms and one or more atoms selected from hydrogen, oxygen and halogen.

2. An apparatus according to claim 1, wherein the composition further contains at least one of:
(c) N₂;
(d) H₂; and
(e) one or more inert gases.

3. An apparatus according to claim 1, wherein the apparatus contains the composition.

4. An apparatus according to claim 1, wherein the one or more alkanes includes tetrafluoromethane.

5. An apparatus according to claim 1, wherein the one or more compounds includes one or more nitrogen hydrides.

6. An apparatus according to claim 1, wherein the one or more compounds includes at least one of ammonia, diazene, hydrazine and salts thereof.

7. An apparatus according to claim 1, wherein the one or more compounds includes nitric acid.

8. An apparatus according to claim 1, wherein the composition further contains at least one of:
(c) N₂; and
(d) H₂.

9. An apparatus according to claim 1, wherein the one or more compounds includes nitrogen dioxide.

10. An apparatus according to claim 1, wherein the composition further contains at least one of:
(c) oxygen;
(d) hydrogen; and
(e) water.

11. An apparatus according to claim 1, wherein the projection beam passes through the space.

12. An apparatus according to claim 1, wherein the space comprises at least a part of the radiation system, or at least a part of the projection system, or at least a part of the radiation system and the projection system.

13. An apparatus according to claim 1, further comprising an activation device configured to produce reactive species of the composition.

14. An apparatus according to claim 13, wherein the activation device produces the reactive species by at least one of exciting and dissociating molecules of at least one of the alkanes and the one or more compounds.

15. An apparatus according to claim 13, wherein the activation device is one of a DUV source, an EUV source, a plasma source, an electrical field, a magnetic field, or an electron source.

16. An apparatus according to claim 13, wherein the activation device includes the radiation system.

17. An apparatus according to claim 1, wherein the composition is a gas, a solid, a liquid, or a beam of molecules.

18. An apparatus according to claim 1, wherein the composition is encapsulated in a microporous media.

19. A device manufacturing method, comprising:
providing a substrate that is at least partially covered by a layer of radiation-sensitive material;
providing a projection beam of radiation using a radiation system;
projecting a patterned beam of radiation onto a target portion of the layer of radiation-sensitive material; and
producing reactive species of the composition, wherein a space through which the projection beam passes comprises a composition containing at least one of (a) and (b), wherein (a) is one or more perhalogenated C₁-C₆ alkanes and (b) is one or more compounds including one or more nitrogen atoms and one or more atoms selected from hydrogen, oxygen and halogen.

20. A method according to claim 19, wherein producing the reactive species includes at least one of the exciting and dissociating molecules of at least one of the alkanes and the one or more compounds.
